(19) United States
(12) Patent Application Publication
(10) Pub. No.: US 2009/0311441 A1
(43) Pub. Date: Dec. 17, 2009

(54) FABRICATION METHOD OF MICRO-OPTICAL ELEMENTS USING PHOTOIMAGEABLE HYBRID MATERIALS

(76) Inventors: Byeong-Soo Bae, Daejeon (KR); Dong-Jun Kang, Daejeon (KR); Kyung-Ho Jung, Daejeon (KR)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/376,088

(22) PCT Filed: Feb. 23, 2007
(86) PCT No.: PCT/KR07/00941

§ 371 Date: Feb. 2, 2009

(30) Foreign Application Priority Data
Aug. 2, 2006 (KR) 10-2006-0073106

(51) Int. Cl. B05D 3/06

(52) U.S. Cl. 427/554; 427/532

(57) ABSTRACT

The present invention provides with a method for fabricating micro- optical elements comprising: forming a photoimageable hybrid coating layer containing oligo-siloxane containing a polymerizable organic functional group, a photoactive monomer capable of forming a polymer or/and a photochemical initiator monomer initiating polymerization by forming a dimer at the time of illuminating a light on a substrate; and forming a micro-optical element having the structure of a desired shape by illuminating a light on the photoimageable hybrid coating layer.

### TECHNICAL FIELD

The present invention relates to photoimageable hybrid materials used in fabricating micro-optical elements, and more particularly, to a method for fabricating micro-optical elements through a simple process without an etching process by using photoimageable hybrid materials capable of softly changing the volume between other dielectric regions as well as adjusting a refractive index by directly illuminating a light.

### BACKGROUND ART

The utility of micro-optical elements such as a microlens rapidly increases as elements for connecting lights in a liquid crystal display device, an optical receiver and an optical communication system, and the micro-optical elements also are required greatly in order to easily process signals in a complicated optical information storage, sensor and image system for a fast transmission of light signals. In order to satisfy these requirements, the high efficiency micro-optical elements capable of easily controlling optical characteristics are recognized as a very important problem and current researches in this field are being briskly conducted.

Currently, a representative method for fabricating micro-optical elements such as a microlens is as follows. First of all, a photoresist is coated on a flat substrate such as a silicon wafer or a glass substrate. After patterning the photoresist by a photomask, development and cleansing processes are performed to form a cylindrical photoresist pattern on a substrate. The photoresist cylindrically patterned on the substrate is heated at a predetermined temperature above a glass transition temperature for example, 150° C. and the patterned photoresist reflows by heating. At this time, the photoresist has a hemispherical shape by surface tension acting on a liquid photoresist and the mask used in fabricating a microlens is formed through a thermal treatment process. A mask and a substrate are etched by a plasma etching like a reactive ion etching in a vacuum chamber to form a microlens arranged in the shape of an array on a substrate.

A dry etching is performed by adopting the photoresist patterned by the above process and formed to have a hemispherical shape as a mask under a proper condition by a plasma etching and the like so that the hemispherical shape of a photoresist is transferred to the etched substrate and then a microlens having a spherical refractive curved surface is obtained.

>Especially, U.S. Pat. No. 5,286,338 suggests a method for obtaining a microlens by plasma-etching a patterned photoresist but the mask and the substrate material (for example, SiO₂) have different reacting materials and produced materials at the time of etching. Therefore, the chemical reaction is very complicated in the middle of etching and continuously changed as time goes by. Accordingly, the patent has advantages in that it is very difficult to obtain an aspherical shape as designed while changing the kind of a gas and a mixing ratio in the middle of etching process and the process is very complicated. In addition, U.S. Pat. Nos. 5,298,366 and 5,324,623 suggest a method for forming a cylindrical photoresist or a resin pattern on a substrate by a photolithography method by using a photoresist and a resin and reflowing them by a heat to form a microlens pattern having a hemispherical shape. This method also asks for complicated processes like etching, development or cleansing, increasing the price of the finally fabricated micro-optical elements and decreasing the reliability.

Therefore, a lot of methods for decreasing the steps of fabricating micro-optical elements have been suggested and recently simple technologies with high efficiency capable of fabricating micro elements at a low cost are suggested. Especially, the development of a direct fabricating technology by directly transferring a micro-structure without etching processes became the direction of an advanced research. The representative technology of the simple and direct fabricating structures draws attention because of a replica method for transferring a master having a micro surface structure onto the surface of a resist material. In particular, the US patent No. 2003-0209819 introduces a method for fabricating a master for direct transfer but this method has limits in being adopted as direct elements because of thermal and mechanical weaknesses of the resist materials and very degraded optical characteristics like a light transmittance. In addition, it is a current situation to show limits as a contact type in which a master should be contacted with a structural material and in a complicated process of fabricating a master and the frequency of the fabricated master.

Accordingly, it is known that the simplest method suggested in order to reduce the steps of processes for fabricating micro-optical elements is a technology for forming micro-optical elements by directly patterning photosensitive materials of which the refractive index and the thickness keep changing by illuminating a light on a coating layer.

The U.S. Pat. No. 4,877,717 discloses a method for forming micro-optical elements by a selective optical illumination by using a polymer layer including at least one photoreactive compound. However, in case that only polymer is introduced as a material, it accompanies problems in the efficiency in fabricating a direct light of the micro-optical elements because of the weakness to heat, degradation of optical characteristics like a light transmittance by illuminating a light and a low photosensitivity to the basic binding polymer.

### DISCLOSURE

### Technical Problem

The present invention is designed to solve the problems of the above-mentioned conventional technology and objects of the present invention are to provide with a method for simply fabricating micro-optical elements by using photoimageable hybrid materials in fabricating micro-optical elements without an etching process of a photolithography process requiring for complicated processes and a method for freely controlling the optical characteristics of micro-optical elements through advantages in a process.

### Technical Solution

The present invention provides with a method for fabricating micro-optical elements comprising: forming a photoimageable hybrid coating layer containing oligo-siloxane containing a polymerizable organic functional group, a photoactive monomer capable of forming a polymer or/and a photochemical initiator monomer initiating polymerization by forming a dimer at the time of illuminating a light on a substrate; and forming a micro-optical element having the structure of a desired shape by illuminating a light on the photoimageable hybrid coating layer.

The oligo-siloxane compound containing a polymerizable organic functional group is represented in the below formula,

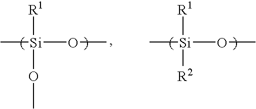

In the above formula, R¹ and R² are carbohydrate compounds of linear, side-chain or cyclic C₁₋₁₂ having at least one functional group selected from the group consisting of acryl group, methacryl group, allyl group, vinyl group and epoxy group.

There occur differences in the volume of molecules, the structure and the concentration and the chemical energy from the portion where a light is not illuminated by modifying molecules such as oligo-siloxane composing a photoimageable hybrid material and monomers by photoreaction due to a light illumination in a predetermined region of a coating layer, thereby causing a photophoresis of oligo-siloxane having a polymerizable organic functional group in the layer coated by a photoimageable hybrid material and doped photosensitive monomers from the region where a light is not illuminated to the region where a light is illuminated, resulting in sufficiently reducing the volatility of photoreactive monomers doped by an adequate photoreaction in the region where a light is illuminated. As a result, the photoimageable hybrid material brings about a continuous change of the volume between the region where a light is illuminated and the region where a light is not illuminated and simultaneously the difference in a refractive index. Therefore, a micro-optical element having the changes of a refractive index and a volume simultaneously is fabricated.

The refractive index of the photoactive monomer in photoimageable hybrid materials is preferably selected from the materials with a higher refractive index than oligo-siloxane having a polymerizable organic functional group.

In general, as the concentration of a photoactive monomer increases, the greater refractive index and thickness can be obtained. At this time, the amount of the added dopant is not specifically limited but 10 to 50wt %, in general.

A polymerizable photosensitive monomer in photoimageable hybrid materials is an acrylate monomer series including methacrylate. Dopants can be classified in accordance with the number of acrylates of acrylate monomers, in other words, the number of functional groups into monomers with one functional group of butyl acrylate, ethyl hexyl acrylate, octyl/decyl acrylate, hydroxyalkyl acrylate, cyclohexyl acrylate and so on, monomers with two functional groups of butane diol diacrylate, butylene glycol dimethacrylate, hexanediol diacrylate, hexanediol dimethacrylate, tripropylene glycol diacrylate and so on, monomers with three functional groups of trimethylopropane triacrylate, trimethylopropane trimethacrylate, pentaerythritol triacrylate, glyceryl propoxylated triacrylate and so on and monomers with four functional groups of pentaerythritol tetraacrylate, dipentaerythritol pentaacrylate and ditrimethylopropane tetraacrylate. Besides, the photoreactive monomer includes cinnamic acid and cinnamic esters series such as methyl cinnamate, ethyl cinnamate, vinyl cinnamate, allyl cinnamate, cinnamyl cinnamate and benzyl cinnamate, carboxylic acid cinnamyls series such as dicarboxylic acid cinnamyl and methacrylic acid cinnamyl, maleic acid series, maleic anhydride series, fumaric acid series, itaconic acid series, itaconic anhydride series, citraconic acid series, citraconic anhydride series and further methyl cinnamic acid, cinnamyl chloride, stilbene and methacrylate series. The present invention may use at least one selected from the photoactive monomers.

A photochemical initiator monomer initiating the polymerization by forming a dimer in photoactive hybrid materials may be at least one monomer selected from the group consisting of benzoinether series, benzylketal series, dialkoxyacetonephenon series, hydroxyalkylphenon series and aminoalkylphenon series.

The above mentioned examples of photochemical initiating monomers initiating polymerization by forming a polymerizable photoactive monomer or a dimer are just examples of materials used in the present invention but are not set forth to limit the present invention.

Hereinafter, the embodiments of the present invention now will be described in detail with reference to the attached drawings.

FIG. 1 (left) shows a process for fabricating a microlens by using a transparent photoimageable hybrid material doped on oligo-siloxane having a polymerizable organic functional group by a photoactive monomer.

First of all, a layer (2) is coated by using a transparent photoimageable hybrid material doped on oligo-siloxane having a polymerizable organic functional group by a photoactive monomer. At this time, the substrate (1) and the photoimageable hybrid layer (2) can be formed by a general method. For example, a spin coating method capable of forming a layer having a uniform thickness can be adopted. Before coating a solution, the surface to be coated should be carefully cleansed. This cleansing process is useful in removing dust which might affect membranes or other external materials.

Next, a light (4) having a mask (3) with a desired shape and a specified wavelength is illuminated on the photoimageable hybrid layer (2) to perform a patterning process. In this case, the patterning process may be performed by using a laser instead of a mask.

In the step of illuminating a light, a desired micro-optical element pattern can be made by using a light corresponding to a wavelength where a photoinitiator reacts out of doped monomers. In general, a wavelength corresponding to an ultraviolet light is used and a micro-optical element having a special shape can be fabricated in accordance with a desired shape.

In order to be used in the above photo-reaction, it is possible to use an organic monomer capable of participating in the reaction to include and fix oligo-siloxane having a polymerizable organic functional group in a cross link instead of a simple photoactive monomer.

A light is partially illuminated on a layer to modify the structure of molecules in a dopant only in the portions where a light is illuminated. A polymerizable oligo-siloxane is coupled with monomers on the layer on which a light is illuminated, a monomer forms a dimer or a transition corresponding to the polymerization of a monomer occurs. Thereby, the matrix, the amount of molecules and the structure of the doped monomer are different from those of the portion where a light is not illuminated, resulting in a selective concentration gradient of a photoactive monomer between the region where a light is illuminated and the region where a light is not illuminated.

The photoactive monomers doped by continuously illuminating a differentiated light on a layer keep moving a light from a region where a light is illuminated to a region where a light is not illuminated. Contrary to this, the monomers at the portion where a light is illuminated are coupled with oligo-siloxane or a dimer is formed from monomers or a transition corresponding to the polymerization of monomers keeps occurring, bringing about an adequate reduction or a complete reduction of the mobility and the volatility of doped photoactive monomers in a photoimageable hybrid material illuminated by a light.

Hereinafter, the transition of the molecular structure in the photoimageable hybrid material occurring at the time of illuminating a light now will be described in the concrete examples in detail.

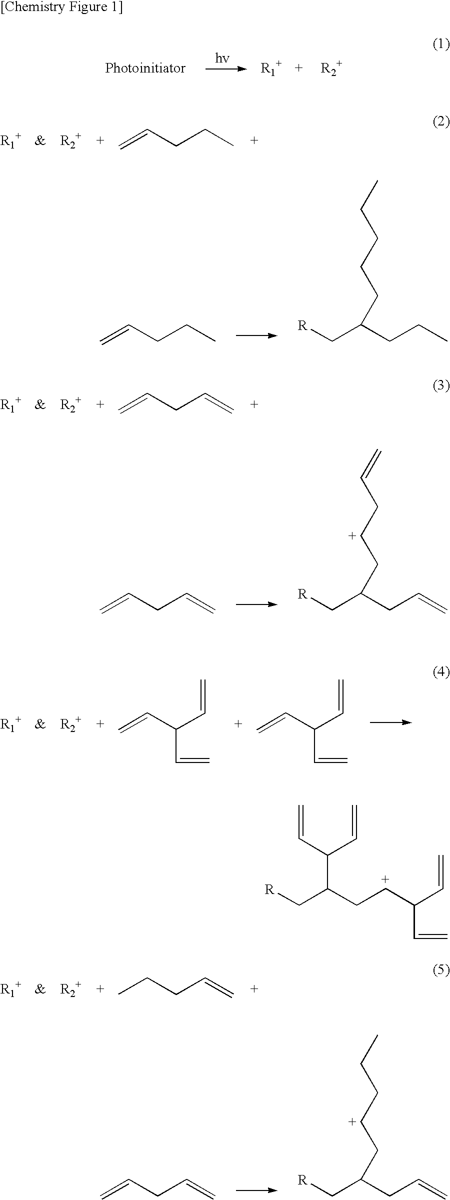

As shown in the above schematic structure, the photochemical initiator monomer in the photoimageable hybrid material forms two radicals as shown in (1) if a light is illuminated, and the formed radicals are coupled like (2) in case of one functional group, (3) in case of two functional groups, (4) in case of three functional groups and (5) in case of mixture of one functional group and two functional groups in accordance with the number of each functional group of acrylate series monomer capable of forming a polymer and having an organic mesh.

The polymerizable acrylate series photoactive monomer in a matrix forms a chain arranged at random to be easily entangled through a photopolymerization reaction at various points of the chain composing a photoimageable hybrid material. Accordingly, as a result of this reaction, the molecular structure of doped monomers and the structure of a matrix at the portion where a light is illuminated differ from those at the portion where a light is not illuminated. Thus, a photophoresis of monomers is performed to cause a polymerization with the matrix and various kinds of photo-reactions at portions where a light is illuminated.

Thereby, the volume and the refractive index at the portion where a light was illuminated are increased in comparison with those at the portion where a light is not illuminated.

The molecular transition process as above can have various shapes and other kinds of reactions can be included besides the above molecular transition process.

In the step of illuminating a light, as the magnitude of an incident beam increases, the number of monomer molecules to be fixed and polymerized onto oligo-siloxane having a polymerizable organic functional group at the region where a light is illuminated is increased more. Therefore, as the magnitude of an incident beam increases, the volume of the region where a light is illuminated and the change of a refractive index are increased more.

In addition, the diameter of a cross-section of a light in a layer and the direction of an axis can be controlled by changing the concentration of a light or the degree of an incident angle.

Therefore, if a wider linewidth is desired, a longer wavelength is preferable and the degree of an incident angle or the concentration of a beam may be reduced when the diameter of a light in a layer is increased.

The wavelength of an exposed beam does not have a clear effect on a polymerizable oligo-siloxane itself and should be selected to initiate the desired molecular transition in a photochemical initiator monomer. Accordingly, the selected specific wavelength is dependent on the components of oligo-siloxane having a specific monomer used as an initiating material and a polymerizable organic functional group in each case. Moreover, a wavelength which dissembles the components of a layer or has a harmful effect on the quality of the final elements should be excluded.

A method for fabricating micro-optical elements through a photo-reaction shown as above may include a process for illuminating a light at the wavelength region with a greater transmittance with respect to a layer through a mask including the desired pattern of micro-optical elements. A technology using this mask is widely known and is a method to be adopted in fabricating a semiconductor device by using a photoresist in general. Furthermore, in case of using a laser, it is possible to directly illuminate a light without the mask.

Electrons, ions and neutrons as well as a simple light source can be used in the step of illuminating a light. With respect to some initiating materials, illuminating particles may be useful in obtaining a large space resolving power.

The next step relates to the development of the pattern of micro-optical elements exposed to a light in a layer. The development can be performed by heating a layer in order to simply volatilize the doped monomer in the region which is not exposed to a light. This step leaves monomers participating in a photo-reaction at the portion where a light is illuminated to a layer and brings a result as follows. In other words, the thickness of a layer is decreased in the unexposed region by removing dopants unexposed to a light and a layer is exposed to a light so that the value of the refractive index is increased due to a photo-reaction between a matrix and a dopant and inside the dopant, resulting in relatively decreasing portions where a light is not illuminated and bringing about a soft change between the portion where a light is illuminated and the portion where a light is not illuminated.

The highest temperature at the time of development can be limited by various physical and chemical characteristics of oligo-siloxane having photoactive monomers and polymerizable organic functional group used in the experiments. What should be considered is a glass transition temperature of oligo-siloxane having a polymerizable organic functional group and the diffusion caused by the temperature of dopants fixed in the oligo-siloxane having a polymerizable organic functional group and undesired chemical changes caused by the heat of materials. It is preferable that the development be performed at a temperature barely affecting the desired characteristics of the final element. For this reason, it is preferable that the photoactive monomer have a proper volatility so that the development occurs at a comparatively proper temperature.

A micro-optical element (5) is automatically formed through this process. FIG. 1 (right) shows a process for fabricating diffraction gratings (4) having various sizes and shapes by a holographic interferometer using a laser (3) at the state (2) that a transparent photoimageable hybrid material doped by a photoactive monomer is coated to oligo-siloxane having a polymerizable organic functional group on the substrate (1). The mechanisms are the same as the tools in FIG. 1 (left).

As shown in FIG. 1C (left and right), the micro-optical elements fabricated by a concentration gradient caused by the change of molecular structure raised by a photo-reaction of a photoimageable hybrid material and a photophoresis caused by the difference of a chemical potential have an advantage that a micro-optical element having a refractive index distribution as well as a soft volume in a device and other dielectric regions can be fabricated. In general, the refractive index corresponding to the change of the cross-section of the magnitude of an exposed light obtains a soft and symmetrically crossing change on the basis of the axial direction. The concentration of fixedly bulky photoactive monomers with a high refractive index becomes the maximum by a photo-reaction and a photophoresis induced by the photo-reaction along an axis of an illuminating beam in general and is decreased gradually from the axis.

After the development, the distribution of the thickness of a layer also becomes the maximum along the axis of an illuminating beam by a photophoresis in general and is decreased gradually from the axis. The thickness of a layer is in proportion to the concentration of monomers concerned in the photo-reaction.

The photophoresis being a major equipment for directly fabricating a light by micro-optical elements made of a photoimageable hybrid material depends not only on the amount of an illuminated light including the magnitude of a light but also the thickness of a layer, the composition and the size of a predetermined region where a light is illuminated very sensitively. These variables are controlled to fabricate micro-optical elements with various shapes and to show a high efficiency in comparison with micro-optical elements fabricated by conventionally widely used methods through these features.

According to the present invention, the micro-optical elements fabricated by a photophoresis described as above were observed to be stable for more than one month at a room temperature and the fixed dopant is hardly diffused.

The bulky and high refractive index dopant was used to increase the thickness of a selected region and a refractive index but it is easily understood by those skilled in the art that a low refractive index dopant can also move a light to a high refractive index matrix from the description of the present invention. If only the distribution of a thickness is to be obtained by a photophoresis, it is sufficient that the dopant and the matrix have the same refractive index. The above method is very useful in fabricating micro-optical elements having a regular change in a layer.

The microlens fabricated in the above-described way, an array and micro-optical elements such as diffraction gratings having a periodic array are very useful in being applied as a very important interline-transfer element capable of improving fill factors in an image sensor of an optical communication element, CMOS and CCD.

It is announced that a photophoresis is mainly described with respect to fabricating micro-optical elements concerning oligo-siloxane having a polymerizable organic functional group and photoactive monomers, but densification and condensation and so on by other several tools besides the photophoresis exist as the tools of the present invention.

### Advantageous Effects

As known from the above description of the present invention, according to the present invention, it is possible to simply manufacture high efficiency micro-optical elements of a photolithography progress requiring for a complicated process in fabricating micro-optical elements without an etching process and freely control the optical characteristics of micro-optical elements through the advantages of the progress.

### DESCRIPTION OF DRAWINGS

FIG. 1 is a process view of micro-optical elements according to the present invention;

FIG. 2 shows a 3D picture of a surface profiler regarding the phenomenon of photophoresis of a micro-optical structure (circle (2a) and line (2b)) depending on the amount of an illuminated light of a photoimageable hybrid material observed by the present invention and a view showing the change of a height and a width regarding the phenomenon of photophoresis of a micro-optical structure (circle (2a) and line (2b)) depending on the amount of an illuminated light;

FIG. 3 is a 3D picture of a microlens (3a) fabricated by the present invention and the surface profiler of the array (3b);

FIG. 4 is a view showing an image of a CCD camera with regard to a focal beam from the focal plane of the microlens (4b) fabricated by the present invention and the distribution (4a) of a focal beam of the microlens;

FIG. 5 is a view showing the increase of a height of the pattern of a microlens array fabricated by the present invention in accordance with the change of the thickness of a photoimageable hybrid layer measured by a 3D surface profiler;

FIG. 6 is a view showing the change of a focal distance of a microlens array in accordance with the change of a height of the pattern of a microlens array fabricated by the present invention in accordance with the change of a thickness of a photoimageable hybrid layer;

FIG. 7 is a view showing the increase of a height of the pattern of a microlens array fabricated by the present invention in accordance with the change of the composition of a photoimageable hybrid layer measured by a 3D surface profiler;

FIG. 8 shows the change of a focal distance of a microlens array in accordance with the change of the pattern of the height of the microlens array fabricated by the present invention in accordance with the change of the composition of a photoimageable hybrid layer;

FIG. 9 is a view taken by an optical microscope of a diffraction grating fabricated by illuminating a direct laser by an holographic interferometer in accordance with the present invention without a mask (1-a Fresnel lens by a beam (9a), 2-2D linear diffraction grating by a beam (9b), 3-2D hexagonal diffraction grating by a beam (9c) and 4-2D rectangular diffraction grating by a beam (9d)); and

FIG. 10 shows a CCD camera image regarding diffraction effects of diffraction gratings fabricated by illuminating a direct laser by an holographic interferometer in accordance with the present invention without a mask (Fresnel lens (10a), 2D linear diffraction grating by a beam (10b), 2D hexagonal diffraction grating by a beam (10c) and 2D rectangular diffraction grating (10d)).

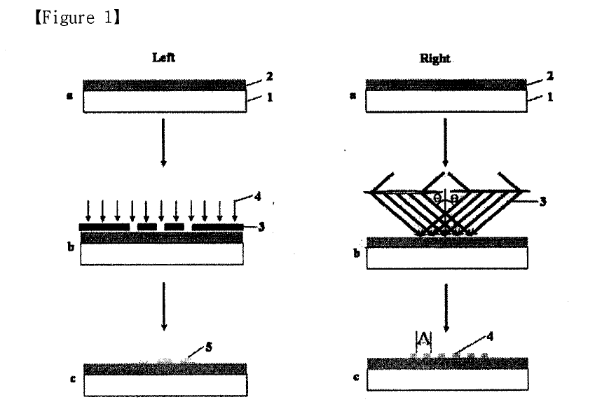

### BEST MODE

Hereinafter, embodiments of the present invention will be described in detail with reference to the attached drawings.

The below embodiments are set forth to describe the contents of the present invention but are not to be construed to limit the present invention.

<Embodiment 1>

0.01N hydrochloric acid is added to 3-methacryloxypropyltrimethoxysilane (MPTMS) at a mole ratio of 1:1 and is stirred for one hour at a room temperature, perfluorodecyltrimethoxysilane (PFAS) is added to MPTMS to have a mole ratio of 3:1 and is stirred for 20 minutes, 0.01N hydrochloric acid in the same amount is added and is stirred for two hours, zirconium normal propoxide (ZPO) is added to methacrylic acid (MMA) at a mole ratio of 1:1 so that MPTMS:PFAS has a mole ratio of 3:1:0.7 and is stirred for 60 minutes and 0.01N hydrochloric acid in the same amount is added and is stirred for 20 hours to gain a methacryl-fluoro-silica-zirconia-hybrid material.

Methylmethacrylate is added by 15 mol % of the entire alkoxide as a photoactive monomer for polymerization, and benzyldimethylketal (BDK) is added by 15 mol % of the entire alkoxide as a photochemical initiator monomer capable of forming a dimer for polymerization and is stirred again to manufacture a photoimageable hybrid solution until the monomer is completely dissolved. After the completed photoimageable hybrid solution is coated on a silicon wafer by using a spin coater, a light is illuminated on the coating layer by using a halogen lamp to dry it for 5 hours at 150° C. The increase of the refractive index and the thickness in accordance with the amount of the illuminated light is measured by a prism coupler and the changed amount is shown in the table 1.

TABLE 1

| Amount of | | |
|---|---|---|
| illuminated | Increase of refractive index | Increase of thickness |
| ultraviolet light | (%) | (%) |
| 0 J | 0.00 | 0.00 |
| 20 J | 0.65 | 8.5 |
| 150 J | 0.95 | 11.3 |
| 250 J | 1.24 | 13.4 |
| 400 J | 1.54 | 15.6 |

<Embodiment 2>

Except that methylmethacrylate added as a photoactive monomer for polymerization in the embodiment 1 is fixed to 15 mol % and benzyldimethylketal (BDK) as a photochemical initiator monomer is mixed at a mole ratio with respect to the entire alkoxide shown in the below table 2, the same method as in the embodiment 1 was performed and a refractive index and the increased amount of a thickness were measured after a light is finally illuminated. The result in accordance with the embodiment 2 was shown in the below table 2.

TABLE 2

| | Increase of refractive index | Increase of thickness |
|---|---|---|
| Amount of BDK (%) | (%) | (%) |
| 1 | 0 | 0 |
| 10 | 0.7 | 7.5 |
| 20 | 1.5 | 21 |
| 30 | 2.1 | 32 |
| 40 | 2.6 | 39.6 |
| 50 | 2.95 | 47 |

<Embodiment 3>

Except that a photo initiator BDK added to the methacryl-fluoro-silica-zirconia-hybrid material gained in the embodiment 1 is fixed to 15 mol % of the entire alkoxide, and acrylate series monomers are mixed with methylmethacrylate, butane diol acrylate, trimethylopropane triacrylate by 15 mol % of the entire alkoxide, respectively, the same method as in the embodiment 1 was performed and the result in accordance with the embodiment 3 is shown in the below table 3.

TABLE 3

| Acrylate series monomer | | Increase | |
|---|---|---|---|
| (number of functional | | of refractive | Increase of |
| groups) | Amount (%) | index (%) | thickness (%) |
| methylmethacrylate (1) | 15 | 1.15 | 14 |
| butane diol diacrylate | 15 | 2.45 | 31 |
| (2) | | | |
| trimethylopropane | 15 | 3.4 | 43 |
| acrylate (3) | | | |

<Embodiment 4>

A photoimageable hybrid solution including methylmethacrylate of 15 mol % of the entire alkoxide and BDK of 15 mol % added to the methacryl-fluoro-silica-zirconia-hybrid material gained in the embodiment 1 is coated on a wafer by a spin coater and a lamp is illuminated on a mask having the pattern of a micro-optical structure by different amounts and then it is heat-treated for 5 hours at 150° C.

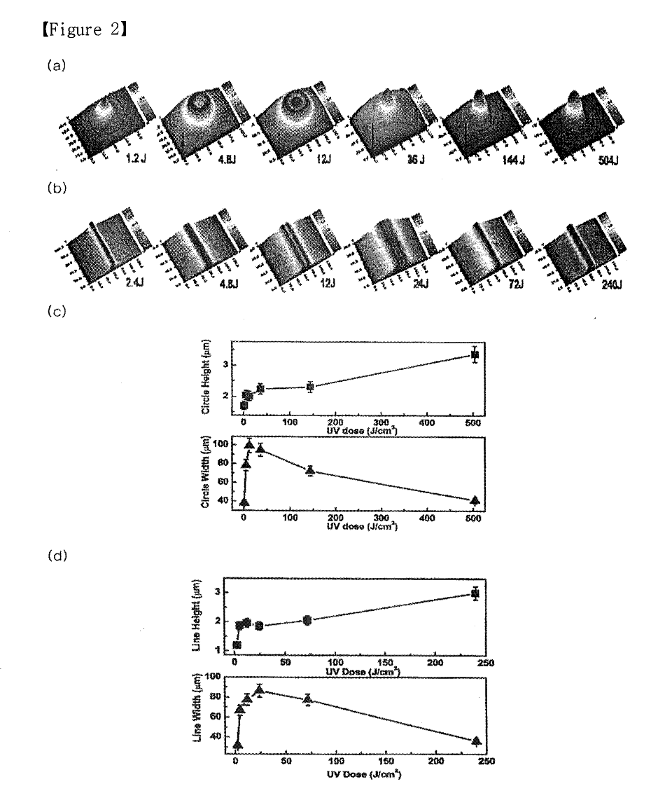

FIG. 2 is a 3D picture of a surface profiler regarding the phenomenon of photophoresis of a micro-optical structure (circle and line patterns) depending on the amount of an illuminated light of a photoimageable hybrid material observed by the above method.

<Embodiment 5>

A photoimageable hybrid solution including methylmethacrylate of 15 mol % of the entire alkoxide and BDK of 15 mol % added to the methacryl-fluoro-silica-zirconia-hybrid material gained in the embodiment 1 is coated on a wafer by a spin coater and a lamp is illuminated on a mask having the pattern of a microlens and an array structure and then it is heat-treated for 5 hours at 150° C.

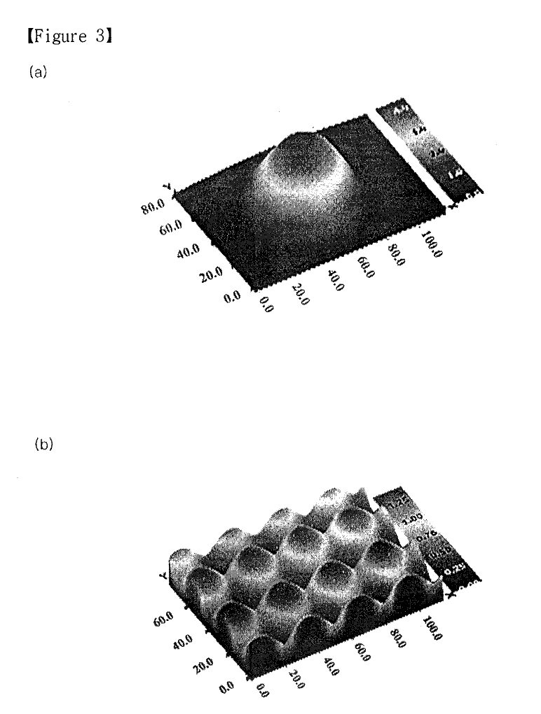

FIG. 3 is a 3D picture of a surface profiler of a microlens (3a) and an array (3b) fabricated by the method.

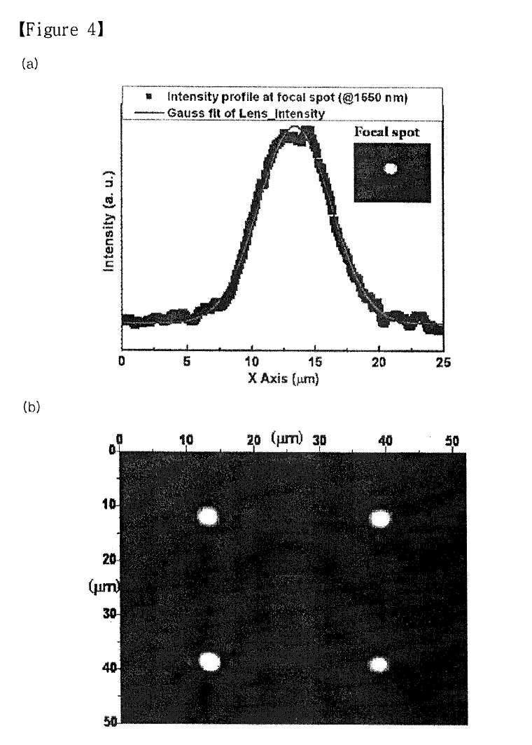

FIG. 4 is an image of a CCD camera with respect to focal beams from a focal plane of the microlens (4a) and an array (4b) fabricated by the method.

<Embodiment 6>

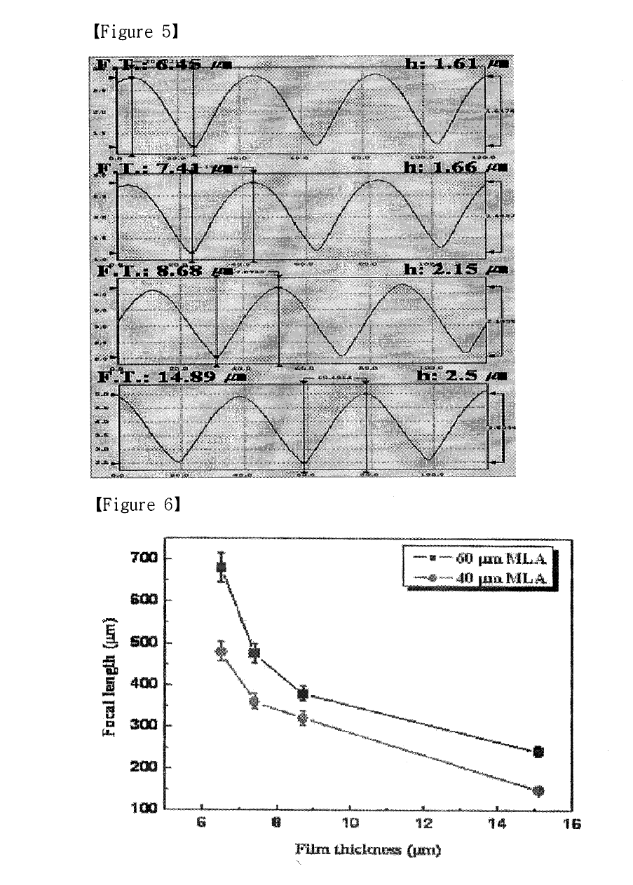

A photoimageable hybrid solution including methylmethacrylate of 15 mol % of the entire alkoxide and BDK of 15 mol % added to the methacryl-fluoro-silica-zirconia-hybrid material gained in the embodiment 1 is coated on a wafer by a spin coater. The coating is performed at a different speed to form a layer having a different thickness and a lamp is illuminated on a mask having the pattern of a microlens and the array structure and then it is heat-treated for 5 hours at 150° C. The increase of the height of a microlens array pattern in accordance with the thickness of a layer is measured by a 3D surface profiler and the change is shown in FIG. 5. The change of a focal length of a microlens array in accordance with the change of a height is shown in FIG. 6.

<Embodiment 7>

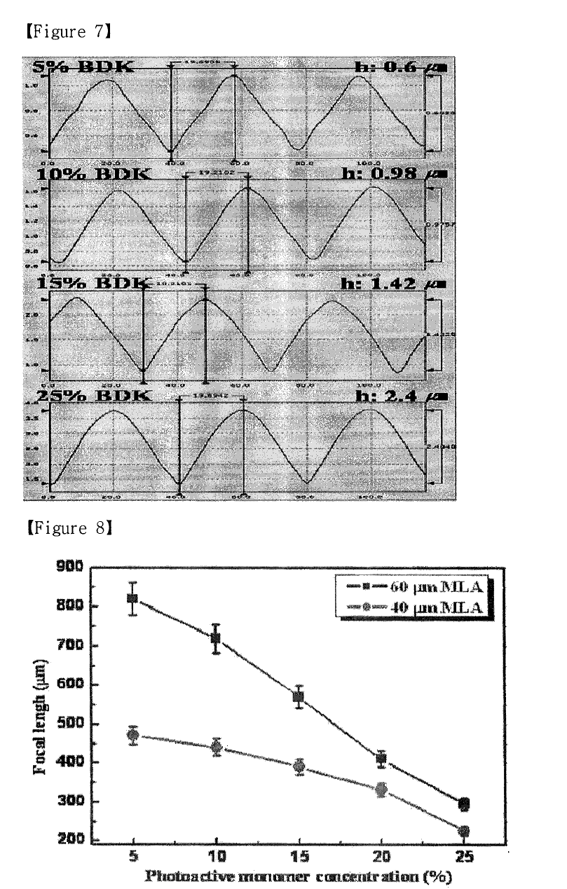

A photoimageable hybrid solution mixing a photoactive monomer, methylmethacrylate fixed to 15 mol % of the entire alkoxide in the methacryl-fluoro-silica-zirconia-hybrid material gained in the embodiment 1 and the photoinitiator BDK of 5%, 10%, 15% and 25% of the entire alkoxide is coated on a wafer by a spin coater. A lamp is illuminated on a mask having the pattern of a microlens and a array structure and then it is heat-treated for 5 hours at 150° C. The increase of the height of the microlens array pattern in accordance with the thickness of a layer is measured by a 3D surface profiler and the change is shown in FIG. 7. The change of a focal length of a microlens array in accordance with the change of a height is shown in FIG. 8.

<Embodiment 8>

A solution including methylmethacrylate of 15 mol % of the entire alkoxide and BDK of 15 mol % added in the methacryl-fluoro-silica-zirconia-hybrid material gained in the embodiment 1 is coated on a wafer by a spin coater and a holographic interferometer is designed in accordance with the number of beams by using a He—Cd laser having the wavelength of 325 mm without a mask. A laser light is directly illuminated and then it is heat-treated for 5 hours at 150°0 C.

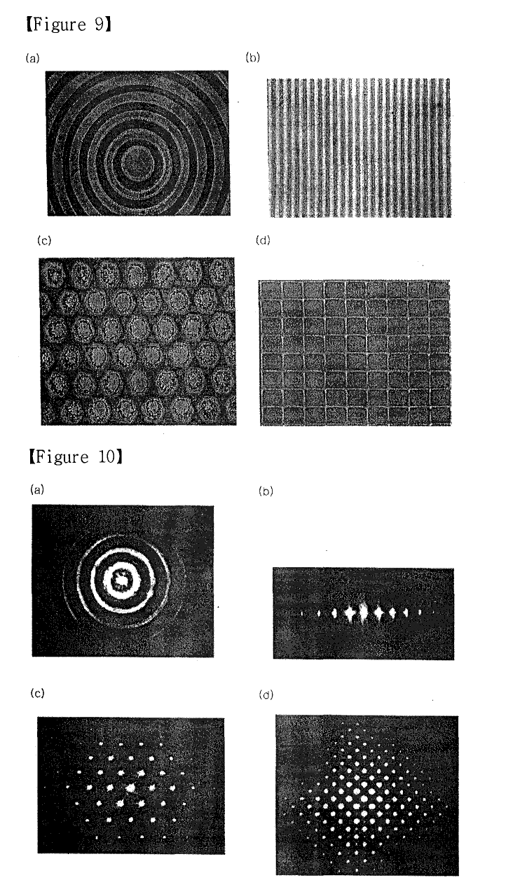

FIG. 9 is a view taken by an optical microscope of a diffraction grating fabricated by illuminating a direct light by an holographic interferometer in accordance with the present invention without a mask (1-a Fresnel lens by a beam (9a), 2-2D linear diffraction grating by a beam (9b), 3-2D hexagonal diffraction grating by a beam (9c) and 4-2D rectangular diffraction grating by a beam (9d)).

FIG. 10 shows a CCD camera image regarding diffraction effects of diffraction gratings fabricated by illuminating a direct laser by an holographic interferometer in accordance with the present invention without a mask (Fresnel lens (10a), 2D linear diffraction grating by a beam (10b), 2D hexagonal diffraction grating by a beam (10c) and 2D rectangular diffraction grating (10d)).

### INDUSTRIAL APPLICABILITY

According to the present invention, high efficiency micro-optical elements can be simply fabricated without an etching process of a photolithography process requiring for a complicated process in fabricating micro-optical elements and further control optical characteristics of the micro-optical elements by the advantages in a progress.

1. A method for fabricating a micro-optical element comprising:
forming on a substrate a photoimageable hybrid coating layer containing: an oligo-siloxane containing a polymerizable organic functional group, and a photoactive monomer capable of forming a polymer, and optionally a photochemical initiator monomer; and
illuminating the photoimageable hybrid coating layer with a light to form a micro-optical element having a desired shape, wherein the illuminating initiates polymerization of the photoimageable hybrid coating layer by forming a dimer.

2. The method as in claim 1, wherein the micro-optical element comprises a first portion that is illuminated and second portion that is not illuminated, wherein the first and second portions have a different refractive index and thickness.

3. The method as in claim 1, wherein the photoactive monomer is a material with a higher refractive index than the oligo-siloxane having a polymerizable organic functional group.

4. The method as in claim 1, wherein the oligo-siloxane compound containing a polymerizable organic functional group is represented in the below formula, 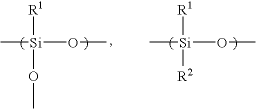
wherein R¹ and R² are independently selected from: a linear, branched, or cyclic C₁-C₂ group having at least one functional group selected from the groups consisting of: an acryl group, a methacryl group, an allyl group, a vinyl group, and an epoxy group.

5. The method as in claim 1, wherein at least a portion of the silicon present in the oligo-siloxane compound containing a polymerizable organic functional group is substituted by a metal.

6. The method as in claim 5, wherein the metal is selected from the group consisting of: titanium, zirconium, aluminum and germanium.

7. The method as in claim 1, wherein the polymerizable photoactive monomer is selected from the group consisting of: an acrylate, a cinnamic acid, a cinnamic esters, a carboxylic acid, a cinnamyl, a maleic acid, a maleic anhydride, a fumaric acid, an itaconic acid, an itaconic anhydride, a citraconic acid, a citraconic anhydride, a methyl cinnamic acid, a cinnamyl chloride, a stilbene, and a methacrylate monomers.

8. The method as in claim 1, wherein the photochemical initiator monomer is selected from the group consisting of: a benzoinether, a benzylketal, a dialkoxyacetonephenone, a hydroxyalkylphenone, and an aminoalkylphenone.

9. The method as in claim 1, wherein the illuminating is carried out by forming a mask with a desired pattern on the photoimageable hybrid coating layer.

10. The method as in claim 1, wherein the illuminating is carried out by directly illuminating the photoimageable hybrid coating layer using a laser without a mask.

11. The method as in claim 1, wherein the illuminating is carried out by directly illuminating the photoimageable hybrid coating layer using a holographic interferometer of a laser without a mask.

12. The method as in claim 1, wherein the micro-optical elements are selected from: a microlens, an array, a diffraction grating, and a waveguide.
